(19) United States
(12) Patent Application Publication
(10) Pub. No.: US 2024/0382784 A1
(43) Pub. Date: Nov. 21, 2024

(54) FIRE MITIGATION DEVICE AND METHODS OF USE

(71) Applicant: Bushfire Mitigation Solutions LLC, Austin, TX (US)

(72) Inventors: James Greer, Austin, TX (US); Andrew Greer, Melbourne (AU)

(21) Appl. No.: 18/592,354

(22) Filed: Feb. 29, 2024

Related U.S. Application Data
(60) Provisional application No. 63/466,452, filed on May 15, 2023.

(51) Int. Cl. A62C 2/06

(52) U.S. Cl. CPC A62C 2/06

(57) ABSTRACT

A fire mitigation device may comprise a mesh screen of interlocking wires, with the purpose of protecting against all of radiant heat, embers, and direct flame, each of which may be present during a wildfire event. The wire mesh screen may be pre-framed or cut from a roll. The wire mesh screen may be placed or fitted over vents or other orifices of a structure, wrapped around a structure or feature to “screen it in,” or placed in a free-standing manner around a feature or structure in order to protect it from damage due to wildfire.

### CROSS-REFERENCE TO OTHER APPLICATIONS

The present application claims the benefit of U.S. Provisional Patent Application No. 63/466,452, filed May 15, 2023, entitled, “Screening Barrier and Methods of Use,” the entire contents of which are incorporated herein by reference.

### TECHNICAL FIELD

The present technology relates to a mesh fire mitigation device and methods of use. More particularly, a mesh fire mitigation device designed to be used for the purpose of fire mitigation and structure protection against the three dangers of wildfire: radiant heat, embers, and direct flame.

### BACKGROUND

### Sources of Danger From Wildfires

In a wildfire event, structures are particularly vulnerable to three threats: radiant heat, ember attack and direct flame. These threats can pose meaningful risks to structures and may result in structural loss when wildfire events occur. These threats may also result in ignition of combustible materials in or around a structure, which will then create a “domino effect” and threaten nearby structures. In addition, during a wildfire event, there are often strong winds that contribute to the damage of structures. It is not uncommon for objects to be picked up and collide against buildings, causing damage and potentially creating openings in the structure. Wind can carry combustible material or debris into or over a defensible space that can then be used as a fuel source to spread a wildfire.

Radiant heat is a result of electromagnetic radiation emitted by a fire. When that radiation contacts a combustible material, the radiant energy is converted into heat. When radiant heat is absorbed by a combustible material, the object catches fire if its ignition temperature is reached. A structure can be damaged from radiant heat by either melting or actual combustion if a wildfire heats it to its ignition point.

Ember attacks account for up to 90% of structure ignitions during wildfire events. Embers (also called firebrands) from wildfires can travel ahead of the wildfire and ignite spot fires on or around a structure. Embers may appear in the form of burning twigs or leaves that are small enough to be carried by the wind and land on or around a structure. Embers may be transported by strong winds. Embers may enter a structure through any opening in a structure, including gaps and vents in the structure's exterior as well as under decking or through open windows. Embers that have entered a structure may then ignite material on the inside of the structure.

Direct flame poses a danger to a structure when a fire is burning close enough to allow flames to touch the structure. Direct flame may be affected by strong winds and the flame can be blown sideways. Such direct contact from a flame will heat the building materials of the structure and may ignite any combustible materials.

### Methods of Mitigating Danger From Wildfires

Methods that exist to protect against the dangers of wildfires include the creation of defensible space around a structure, wherein measures may be taken to reduce the available fuel for wildfires such as using hardscape like gravel, pavers, concrete, or other non-combustible material within a specified radius around the structure. Other defensible space may consist of trimmed grass and trees and the diligent removal of combustible debris. The objective of defensible space creation is to reduce the fuel available for wildfires as they approach a structure, and therefore reduce the intensity of any ember attacks, direct flame and radiant heat that the structure experiences.

Another method of protecting against the dangers of wildfires is the use of “active” protection devices such as fire extinguishers and sprinkler systems. Active protection devices will typically include both a detection sensor that has been programmed to sense the risk approaching (e.g., a temperature sensing device) and an actuator device that receives a signal from the detection sensor and then turns on something to counteract the risk (e.g., a pump). Such devices will be designed to activate in response to a triggering event, such as radiant heat. Once activated, the active protection device may attempt to block, repel, or extinguish the wildfire threats. Often, active protection devices must be replaced after they are triggered or used and therefore they are often considered “single-use.” Even when they are not single-use, they will typically need to be calibrated, checked, maintained, and replaced. In some cases, active protection devices may not be independent and may instead rely on other services for function. For example, a detection sensor may require Wifi to be able to send a signal to an actuator device, and during fire the Wifi signal may be lost, or a fire water pump may need electricity to run, and during a wildfire event, electricity may be lost or isolated, limiting the effectiveness of the pump.

Another method of protecting against the dangers of wildfires is the use of passive barriers to slow or stop the advance of the fire. Passive barriers are installed in or around a structure or asset and remain inert and “inactive” during the normal operation of the structure or asset. Protection is provided against the threats of wildfire because the passive barrier is made from material and designed in such a way that it blocks or repels at least one of the three wildfire threats should they approach the structure or asset. A passive barrier may remain in place for the life of the structure or asset it protects, and may not need to be replaced after one or multiple wildfire events. Passive barriers are typically always “on” and do not need a separate detection device and corresponding signal, or the same level of maintenance as an active protection device. Therefore, passive barriers may be more effective during wildfire events.

Conventional practices in wildfire mitigation and prevention teach that it is most effective to utilize combinations of methods such as creating defensible space around a structure while also “hardening” the structure by adding passive barriers to any vents or openings. Active protection devices may also be incorporated into the process of hardening the structure. The defensible space may slow or halt the wildfire's advance while the passive barriers may protect against ignition of the structure by embers that find their way past the external walls of the structure and arrive at internal materials of the structure, which may be more flammable.

Passive barriers may also be incorporated around the structure as discrete barriers, not attached to the structure itself but surrounding the area that the structure is in. Defensible space may then be created both around the passive barriers and in the area between the passive barriers and the structure itself.

In the aforementioned uses of passive barriers, one challenge that may be faced is that the passive barrier may not allow a large amount of air to flow through it. If placed over a vent, this means that airflow into the vent is reduced and moisture will build up within the structure. If placed around the structure, the passive barrier may deflect wind and the embers it carries up and over it. As such, materials and methods used in the making of passive barriers must allow air to flow substantially through the barrier. Passive barriers that do not allow airflow will have the effect of deflecting strong winds carrying embers. These barriers may in fact further contribute to additional fires being spread because the strong winds can carry the embers to further sites where fires may be started and spread.

In contrast, if air is allowed to flow through the barrier, the barrier may act as a “filter” or “screen” in the event of a wildfire in that it may block embers that are carried by the wind as the wind passes through the barrier. The embers may then either fall to the ground, where they may cause ignition, or they may be held by the barrier until they burn out and then fall to the ground. The latter process is known as “catch, hold, and release.” Thus, passive barriers that catch the embers as the wind passes through may be more effective at limiting the spread of wildfire.

There is a need for a barrier that more effectively provides protection against the three dangers of wildfire: radiant heat, embers, and direct flame.

### SUMMARY

According to an aspect of the present disclosure, a fire mitigation device may comprise a mesh screen made of interlocking wires comprising between 10 and 14 wires per inch. The mesh screen may include a plurality of apertures that have an aperture width of between 0.04 inches and 0.08 inches (between 1.016 mm and 2.032 mm). The mesh screen may have a net free area defined by the percentage area of the mesh screen that does not contain wire, and the wherein the net free area may be between 55% and 70%.

According to another aspect of the present disclosure, the fire mitigation device may further comprise a second mesh screen of interlocking wires comprising 8 to 14 wires per inch. The second mesh screen may include a plurality of second apertures that have a second aperture width of between 0.02 inches and 0.12 inches (between 0.5 mm and 3.048 mm). The second mesh screen may have a second net free area defined by the percentage area of the second mesh screen that does not contain wire. The second net free area may be between 50% and 75%. The mesh screen and the second mesh screen may be stacked together.

According to another aspect of the present disclosure, a method of using a fire mitigation device may comprise the step of placing a fire mitigation device onto a vent or opening in a structure to be protected to create a barrier against direct flame, embers, and radiant heat. Optionally, the method may comprise the step of fastening the mesh screen onto the structure so as to eliminate any gaps that would allow sizable embers to enter the structure or to prevent wind or wildlife from removing it.

According to another aspect of the present disclosure, a method of using a fire mitigation device may comprise the step of at least partially wrapping a structure to be protected with a fire mitigation device to create a barrier against direct flame, embers, and radiant heat. Optionally, the method may comprise the step of fastening the mesh screen on to the structure so as to prevent unwanted removal of the mesh screen by wind, wildlife, or any other cause.

According to another aspect of the present disclosure, a method of using a fire mitigation device may comprise the step of placing a fire mitigation device in an open area so as to block a wildfire from advancing through it.

It is to be understood that both the foregoing general description and the following detailed description describe various embodiments and are intended to provide an overview or framework for understanding the nature and character of the claimed subject matter. The accompanying drawings are included to provide further understanding, and are incorporated into and constitute a part of this specification. The drawings illustrate embodiments described herein, and together with the description to serve to explain the principles and operations of the claimed subject matter. Other objects, advantages, and novel features of the present disclosure will become apparent from the following detailed description of one or more preferred embodiments when considered in conjunction with the accompanying drawings.

### BRIEF DESCRIPTION OF SEVERAL VIEWS OF THE DRAWINGS

The following is a description of the examples depicted in the accompanying drawings. The figures are not necessarily to scale, and certain features and certain views of the figure may be shown exaggerated in scale or in schematic in the interest of clarity of conciseness.

FIG. 1 shows a wire mesh as part of a fire mitigation device according to the current disclosure.

FIG. 2 shows an enlarged view of a part of the wire mesh of FIG. 1.

FIG. 3A shows a perspective view of an embodiment of a framed fire mitigation device according to the present disclosure.

FIG. 3B shows a front view of the fire mitigation device shown in FIG. 3A.

FIG. 4A shows a perspective view of an embodiment of a framed fire mitigation device according to the present disclosure.

FIG. 4B shows a front view of the fire mitigation device shown in FIG. 4A.

FIG. 5 shows a fire mitigation device according to the current disclosure and embers, where the fire mitigation device is catching the embers and holding them.

FIG. 6 shows the fire mitigation device shown in FIG. 5 as the embers are releasing from the fire mitigation device and are not smoldering or igniting a cotton pad.

FIG. 7 shows a fire mitigation device according to the current disclosure placed between a flame and a cotton pad, where the cotton pad is not igniting.

FIG. 8A shows a fire mitigation device according to the current disclosure including a single layer of a mesh screen barrier placed in front of a flame.

FIG. 8B shows a fire mitigation device according to the current disclosure including two layers of a mesh screen barrier placed in front of a flame.

FIG. 9A shows a front view of two embodiments of a framed fire mitigation device according to the current disclosure. The top embodiment includes a double layer of a mesh screen barrier and the bottom embodiment includes a single layer of a mesh screen.

FIG. 9B shows a rear view of two embodiments shown in FIG. 9A.

The preceding summary, as well as the following detailed description of certain embodiments of the present disclosure, will be better understood when read in conjunction with the appended drawings. For the purposes of illustration, certain embodiments are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

In the following detailed description, specific details may be set forth in order to provide a thorough understanding of embodiments of the present disclosure. However, it will be clear to one skilled in the art when embodiments of the present disclosure may be practiced without some or all of these specific details. In other instances, well-known features or processes may not be described in detail so as not to unnecessarily obscure the disclosure. In addition, like or identical reference numerals may be used to identify common or similar elements.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. As used herein, “approximately” may generally refer to an approximate value that may, in certain embodiments, represent a difference (e.g., higher or lower) of less than 1% from the actual value. That is, an “approximate” value may, in certain embodiments, be accurate to within (e.g., plus or minus) 1% of the stated value. In certain other embodiments, as used herein, “approximately” may generally refer to an approximate value that may represent a difference (e.g., higher or lower) of less than 10% or less than 5% from the actual value.

The present technology is directed to a fire mitigation device and methods of use thereof, specifically designed for the mitigation of wildfire damage to a structure by preventing or reducing the three major threats from a wildfire event: radiant heat, embers, and direct flame. A fire mitigation device according to the present disclosure may be made of a wire mesh which uses combinations of various physical properties such as material, weave type, mesh count, open area, aperture size, wire diameter, thickness of the mesh, finish on the material, and other factors. The woven structure of the mesh may provide benefits such as high weave tension, self-cleaning properties or case-of-cleaning properties, no moving parts, no reapplication of additive for performance, low or minimal maintenance, and limited or no rust or corrosion. As a result of the various properties of the material and the weave pattern, the fire mitigation device may provide a reduction in radiant heat when placed between a heat source and a target area, compared to a minimal or no reduction in radiant heat without the fire mitigation device. Another result of the various properties of the material and the weave pattern may be that embers larger than the aperture size of the mesh will be caught and held by the mesh, those embers may eventually be released and drop to the ground once they are no longer an ignition threat. Alternatively, the embers may be allowed through the mesh once they have become small enough to pass through. In some embodiments, the embers will only be small enough to pass through once they are too small to pose an ignition threat. Another result of the various properties of the material and the weave pattern may be that direct flame is diffused when the fire mitigation device is placed horizontally above it or otherwise in its path. This may result in less danger of ignition by the flame on the other side of the fire mitigation device.

For purposes of comparison, a different form of a screening barrier such as a fireplace screen may not protect against embers. Importantly, a fireplace screen is designed to allow heat through and has bigger apertures. Instead, a fireplace screen protects against “mini explosions” that occur from burning wood. Furthermore, a fire place screen does not provide protection against wind speed or a volume of embers; accordingly, embodiments prepared according to the present disclosure will typically be superior to a fire place screen in protecting against threats posed by wildfire.

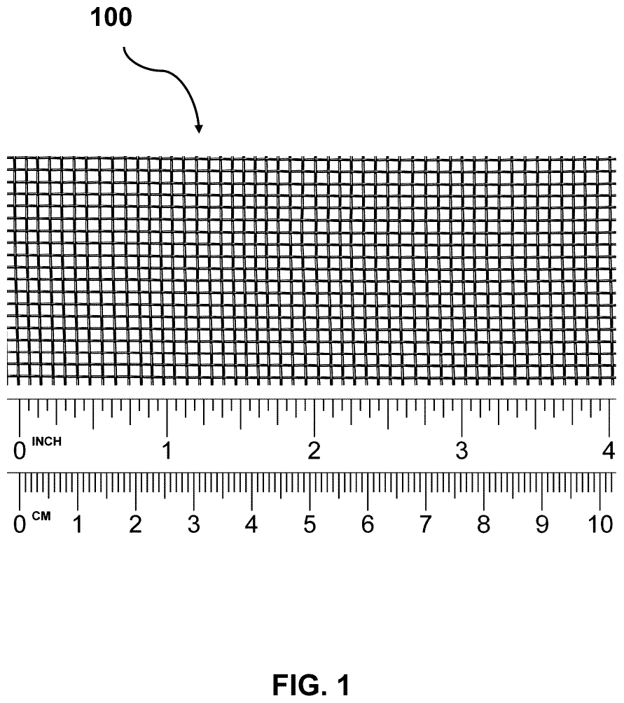

FIG. 1 illustrates an example embodiment of a wire mesh 100 as part of a fire mitigation device according to the current disclosure. FIG. 1 includes a ruler in inches and centimeters for scale. As shown, the wire mesh 100 may comprise 12 wires per inch. According to certain embodiments of the present disclose, a fire mitigation device may be formed from the wire mesh 100, which may be in the form of a roll of wire mesh 100 which could then be cut to a particular size based on the specific application for the fire mitigation device. For example, a roll of wire mesh 100 may have a width of 7.5, 24, 36, 49, or 60 inches, and a length of 50 feet. A fire mitigation device may be cut from a roll of wire mesh 100 and sized to cover a particular vent or opening in a structure.

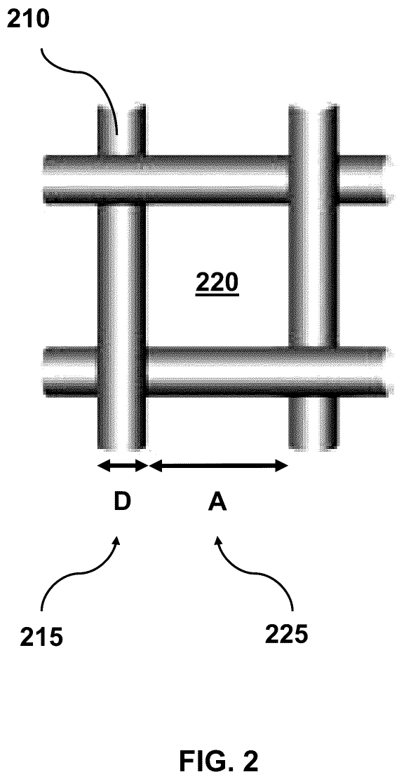

FIG. 2 illustrates an enlarged view of a part of the wire mesh 100 of FIG. 1, showing that the wire mesh comprises wires 210 that have a diameter (D) 215 and apertures 220 that have an aperture width (A) 225.

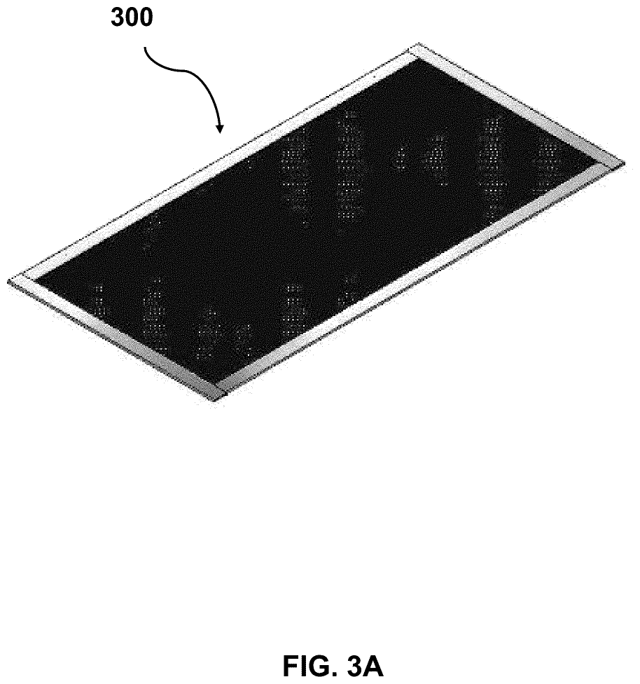

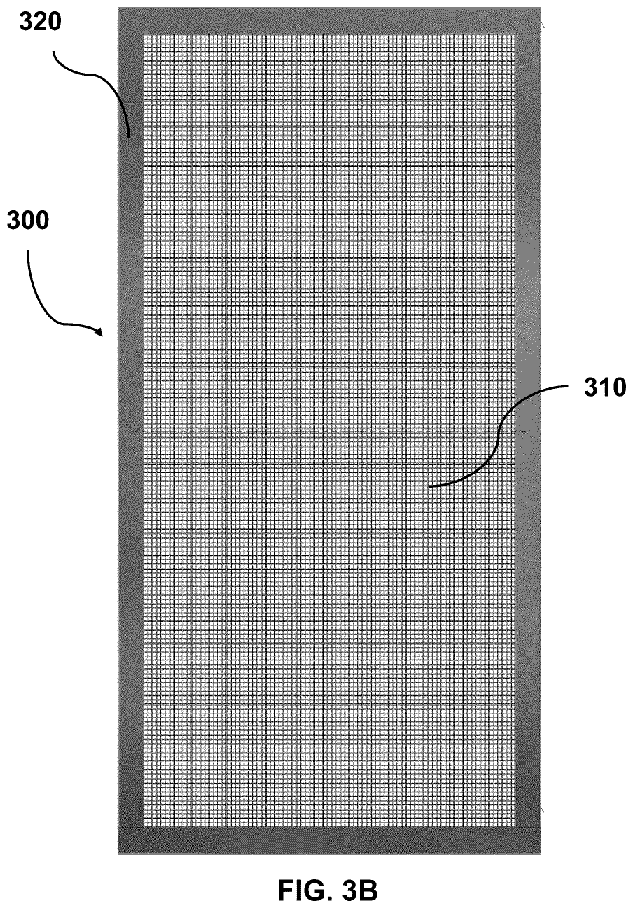

According to other embodiments of the present disclosure, a fire mitigation device may be a framed fire mitigation device. An example of a framed fire mitigation device is illustrated in FIGS. 3A and 3B. As shown in these figures, a fire mitigation device 300 may include a wire mesh 310 surrounded by a frame 320. The frame 320 may be attached to the wire mesh 310 by any suitable method, including welding the frame 320 to the wire mesh 310, fitting the frame 320 over the outer edges of the wire mesh 310 and then crimping the frame 320 closed, or wrapping the wire mesh 310 over and around the frame 320. The fire mitigation device 300 may be at least approximately rectangular, as shown in FIGS. 3A and 3B. In other embodiments, a fire mitigation device may have a different shape.

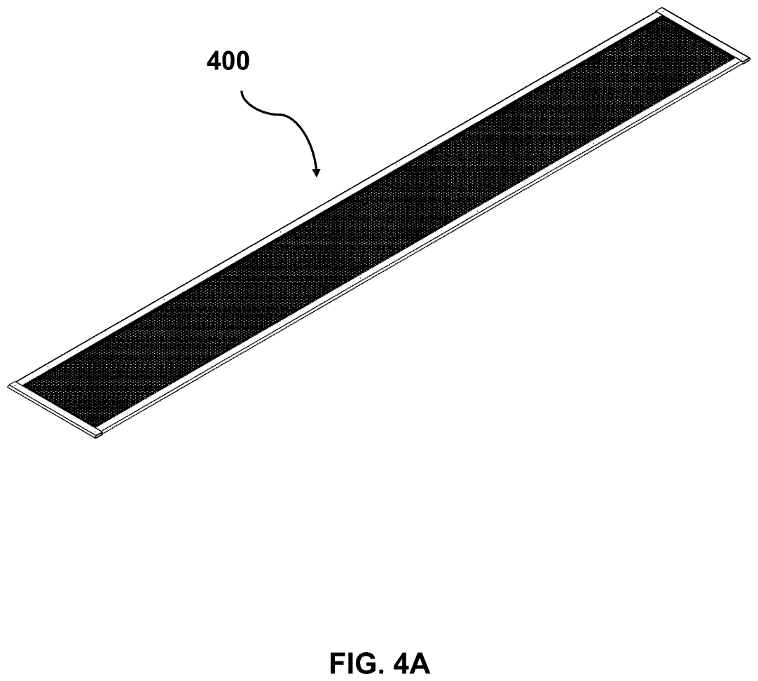

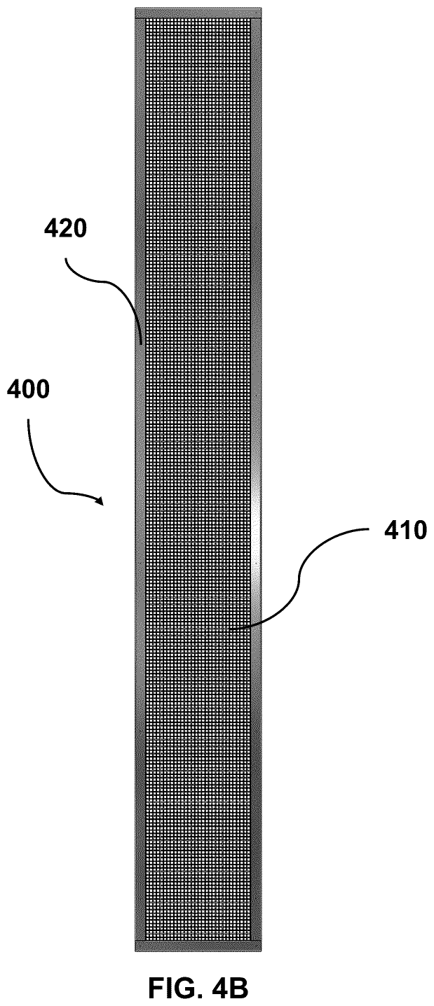

Another example of a framed fire mitigation device is illustrated in FIGS. 4A and 4B. As shown in these figures, a fire mitigation device 400 may include a wire mesh 410 surrounded by a frame 420.

One benefit of the present disclosure is that using a wire mesh with, in an embodiment, a small aperture (about 0.0657″) with a percentage opening of about 62% and a wire diameter of 0.18″ in front of an orifice would not meaningfully impact air flow through the mesh and such small apertures may have substantially improved handling of embers that the art is not thought to have been previously aware of.

The aperture sizing of the mesh may dictate, among other things, the airflow that is allowed through the mesh and the size of embers that will be caught by the mesh. The aperture sizing also affects the net free area of the mesh, which may also dictate the air flow that is allowed through the mesh. The net free area (or net open area) is defined by the percentage area of the mesh screen that does not contain wire and is free or open (aperture area). Aperture widths between 0.04 and 0.08 inches, or between 0.05 and 0.07 inches, or between 0.0625 and 0.0675 inches (between 1.5875 and 1.7145 mm), and a net free area of between 50% and 75%, or between 55% and 70%, or between 60% and 65%, have been found to be ideal for protection against one or more of radiant heat, embers, and direct flame. In one embodiment, the aperture size is exactly or approximately 0.0657 inches and the net free area of the mesh is exactly or approximately 62%. In another embodiment, the aperture size is exactly or approximately 1/16″ (0.0625 inches). According to certain embodiments, including embodiments involving stacking multiple layers of mesh, the aperture size (of one or more layers) may be between ⅛″ and 1/16″ (between 0.125 and 0.0625 inches).

The type of wire material used in the mesh may dictate the rigidity of the mesh and the corrosion-resistance of the mesh, among other things. In an embodiment, a non-corrosive, low maintenance steel such as 316 stainless steel is used. In another embodiment, a non-corrosive, low maintenance steel such as 304 stainless steel is used. Typically, 316 and 304 stainless steel would not be used in combination, but according to certain embodiments of the present disclosure, combinations of 316 and 304 stainless steel wires may be used. The wire material should be non-combustible, with a high melting point and a high tensile strength.

The size of the wires used in the mesh may dictate the rigidity of the mesh and the mesh's ability to protect against various threats, among other things. Ideally, wire diameters between 0.01 inches (about 0.25 mm) and 0.05 inches (about 1.25 mm) are used to make the mesh. In one embodiment, the wire diameter is between 0.0175 and 0.035 inches. In another embodiment, the wire diameter is 0.018 inches.

The density of wires in the weaving of the mesh may dictate aperture sizing of the mesh, the net free area of the mesh, the rigidity of the mesh, the durability of the mesh, and many other things. Embodiments of the present disclosure employ wire mesh comprised of between 10 and 14 wires per inch, or between 10 and 12 wires per inch. For example, an embodiment may employ wire mesh comprising 11, 12, or 13 wires per inch.

According to certain embodiments of the present disclosure, the mesh screen may have a thickness of between 0.025 and 0.05 inches.

In some embodiments, the fire mitigation device is created by creating multiple layers of wire mesh to be placed adjacent to each other so that radiant heat, embers and direct flame must pass through multiple layers of mesh instead of one. Utilizing multiple layers of mesh in a fire mitigation device may increase resistance to radiant heat, embers, and direct flames while decreasing the air flow that is allowed through the mesh. Testing performed on single-layer and double-layer fire mitigation devices has demonstrated that single layer fire mitigation devices can be as effective in some embodiments as double-layer fire mitigation devices. As shown in more detail below, testing of embodiments against embers (vertically and horizontally), radiant heat (vertically), and direct flame (vertically) demonstrated that a single layer fire mitigation device can be a highly effective and cost-efficient barrier. Comparably, certain double-layer fire mitigation devices performed very similarly. Given the comparable performance, single-layer embodiments may be preferred to double-layer embodiments. In other cases or uses, double-layer embodiments may be preferred to single-layer embodiments.

When using multiple layers of wire mesh, it may not be necessary for each layer to have the same sizing. For example, a second layer may have an increased net free area to allow for greater air flow through the second layer, or a decreased net free area in an effort to provide increased resistance. For example, a fire mitigation device according to the present disclosure may comprise a first mesh screen of interlocking wires comprising 10 to 14 wires per inch and a plurality of first apertures that have a first aperture width of between 0.04 inches and 0.08 inches, with a first net free area between 55% and 70%, and a second mesh screen of interlocking wires comprising 8 to 14 wires per inch and a plurality of second apertures that have a second aperture width of between 0.02 inches and 0.12 inches, with a second net free area between 50% and 75%. The first and second mesh screens may be stacked together. Additional layers of mesh could additionally be included.

In some embodiments, the wire mesh may be a raw finish. In other embodiments, the wires may be coated in a corrosion-resistant material such as powder coating. The powder coating may have a thickness of between 10 and 100 microns, or between 15 and 50 microns, or between 20 and 25 microns, or 25 microns. Embodiments may also employ powder coating for aesthetic purposes, to match the façade of the structure they are applied to or to camouflage the fire mitigation device. In some embodiments, the powder coating may be a black powder coating, a white powder coating, or a color powder coating. In some embodiments, the coating may increase the heat resistance or heat absorption of the wire mesh. In some embodiments, the wire mesh may be coated with intumescent paint to form an intumescent coating. An intumescent coating is a form of a passive barrier. When exposed to heat, an intumescent coating will be rapidly transformed through sublimation and will expand many times its original thickness (in other words, the coating “swells up”), to form a stable, carbonaceous char. This expanded, swollen char can help to prevent fire from spreading.

In some embodiments, the woven wire mesh may have a high weave tension. A high weave tension may promote strength, flame impingement, heat transfer, and density of the mesh.

In some embodiments, the woven wire mesh may be self-cleaning or easy to clean because the areas or gaps in the interlocking wires may not allow for combustible material buildup. Once an ember is caught, the functionality may allow for “self-cleaning,” meaning the embers can drop away once burned out or small enough to fall. Any debris caught within the apertures may either be cleared with airflow or when cleaned during annual or otherwise time-to-time maintenance. In some embodiments, the material used in the wire mesh is non-magnetic, which may prevent charged particles from attracting to the mesh and blocking the apertures.

Some embodiments may provide an effective minimum of 98% stoppage of soft wood dangerous embers. A dangerous ember, in the art, is an ember larger than 1/16 inch. Smaller embers have been observed to self-extinguish before reaching a flammable area. Some embodiments may catch dangerous embers and other debris that is travelling at high momentum without damage. Some embodiments may withstand direct impact of dangerous embers and debris and may retain shape under harsh mechanical conditions.

Some embodiments may hold dangerous embers while they burn out on the non-combustible stainless steel woven mesh without impacting the aperture and net free area of the mesh. In so doing, the mesh can perform its role of vent and/or guard over time. Some embodiments may release the embers or ash once they are burned out or small enough such that they cannot reignite if they arrive at combustible material.

Embodiments may employ:

| | | |
|---|---|---|
| Mesh Count | Hole Aperture | Diameter Wire |

| | | | | |
|---|---|---|---|---|
| 12 Mesh | 0.067″/1.7018 | mm | 0.016″/0.4064 | mm |
| 12 Mesh | 0.0657″/1.67 | mm | 0.0177″/0.45 | mm |
| 12 Mesh | 0.0652″/1.656 | mm | 0.0181″/0.46 | mm |
| 12 Mesh | 0.0648″/1.646 | mm | 0.0185″/0.47 | mm |
| 12 Mesh | 0.0644″/1.636 | mm | 0.0189″/0.48 | mm |
| 12 Mesh | 0.063″/1.6002 | mm | 0.020″/0.508 | mm |
| 12 Mesh | 0.060″/1.524 | mm | 0.023″/0.5842 | mm |
| 12 Mesh | 0.058″/1.4732 | mm | 0.025″/0.635 | mm |
| 12 Mesh | 0.0553″/1.404 | mm | 0.028″/0.711 | mm |
| 12 Mesh | 0.051″/1.2954 | mm | 0.032″/0.8128 | mm |
| 12 Mesh | 0.048″/1.2192 | mm | 0.035″/0.889 | mm |
| 12 Mesh | 0.042″/1.0668 | mm | 0.041″/1.04 | mm |
| 11 Mesh | 0.0314″/0.80 | mm | 0.059″/1.51 | mm |
| 10 Mesh | 0.080″/2.032 | mm | 0.023″/0.582 | mm |
| 10 Mesh | 0.0787″/2.00 | mm | 0.0197″/0.50 | mm |
| 10 Mesh | 0.0750″/1.905 | mm | 0.0250″/0.635 | mm |
| 10 Mesh | 0.072″/1.8288 | mm | 0.028″/0.71 | mm |
| 10 Mesh | 0.075″/1.905 | mm | 0.025″/0.64 | mm |
| 10 Mesh | 0.068″/1.7272 | mm | 0.032″/0.81 | mm |
| 10 Mesh | 0.065″/1.651 | mm | 0.035″/0.889 | mm |
| 10 Mesh | 0.059″/1.4986 | mm | 0.041″/1.04 | mm |
| 10 Mesh | 0.053″/1.3462 | mm | 0.047″/1.19 | mm |

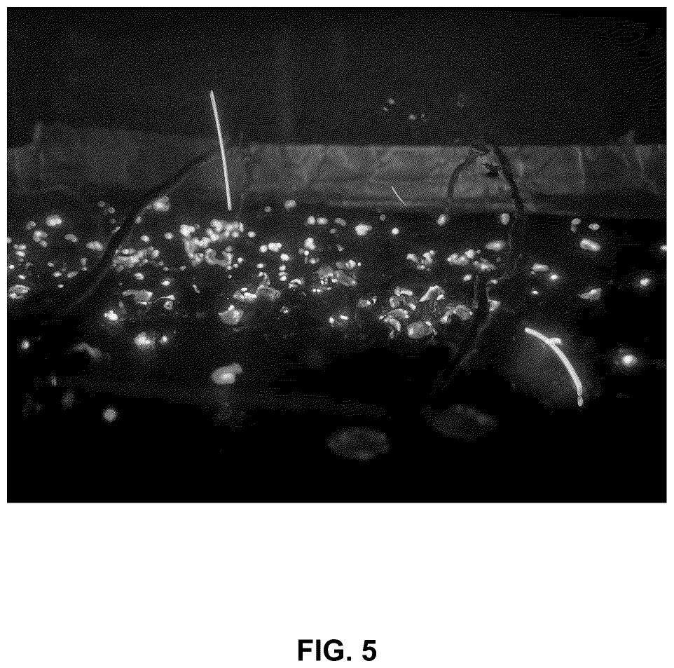

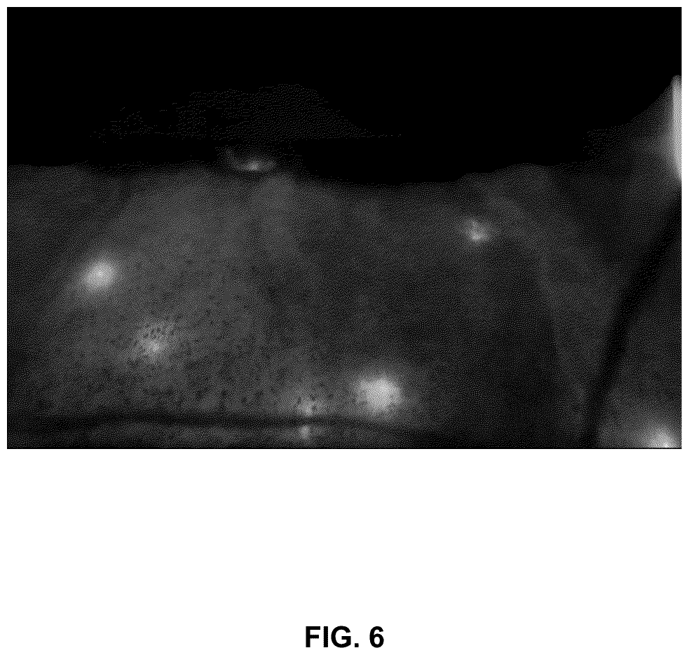

FIG. 5 shows a fire mitigation device according to the current disclosure and embers, where the fire mitigation device is catching the embers and holding them. FIG. 6 shows the fire mitigation device shown in FIG. 5 as the embers are releasing from the fire mitigation device and are not smoldering or igniting a cotton pad. The embers no longer pose an ignition threat.

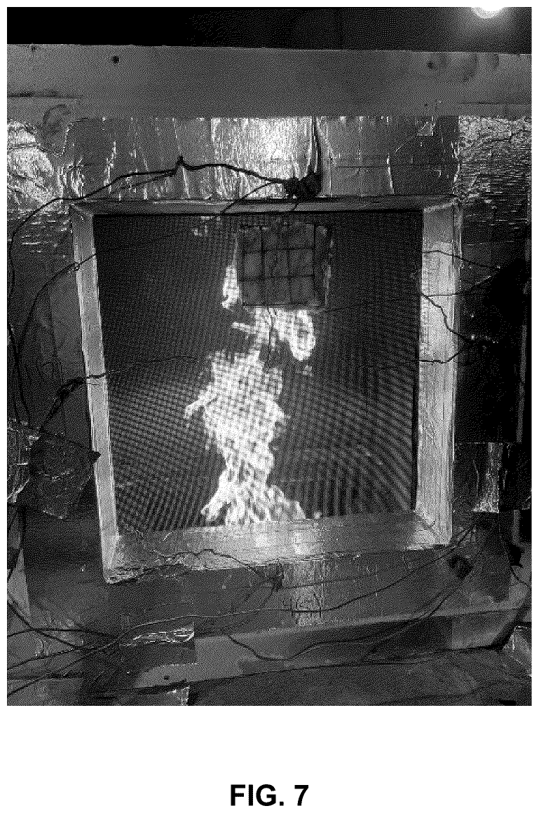

FIG. 7 shows a fire mitigation device according to the current disclosure placed between a flame and a cotton pad, where the cotton pad is not igniting and the temperature where the cotton pad is located remains below 350 degrees Celsius (662 degrees Fahrenheit).

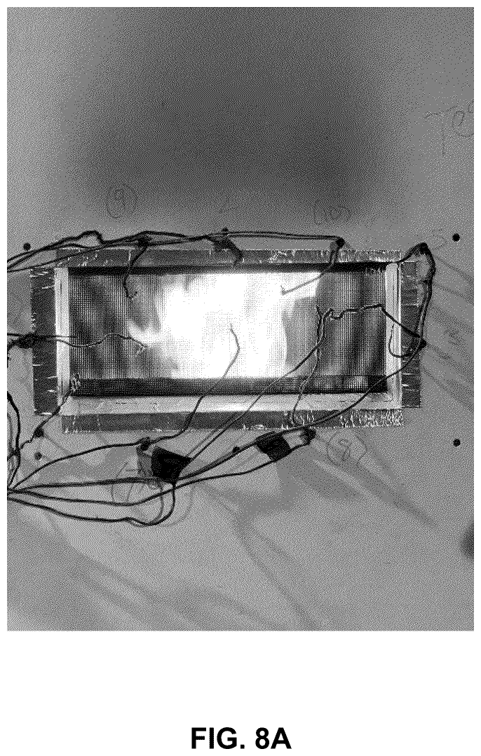

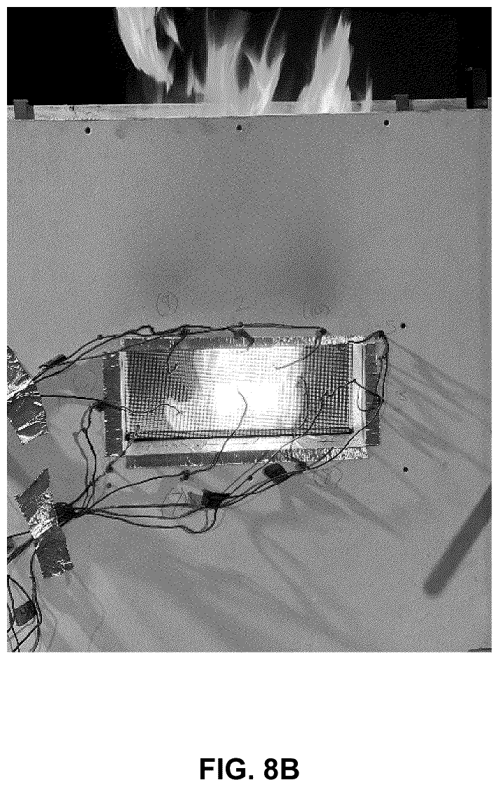

FIG. 8A shows a fire mitigation device according to the current disclosure including a single layer of a mesh screen barrier placed in front of a flame. FIG. 8B shows a fire mitigation device according to the current disclosure including two layers of a mesh screen barrier placed in front of a flame.

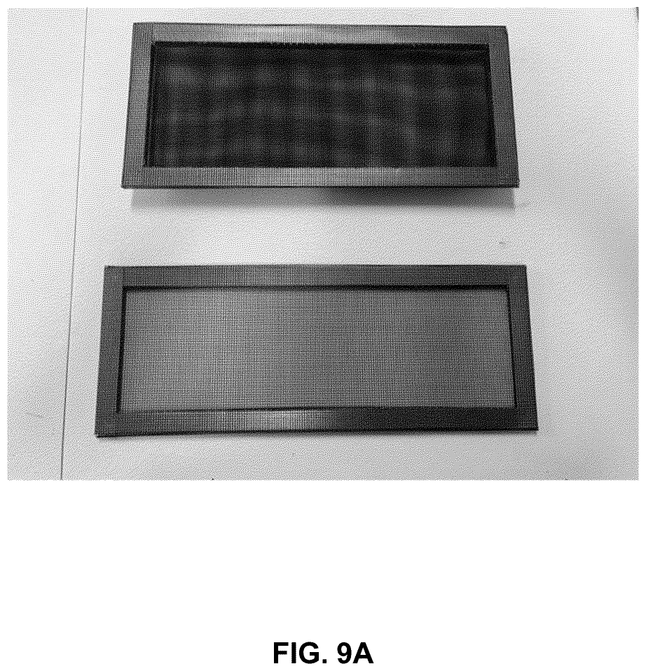

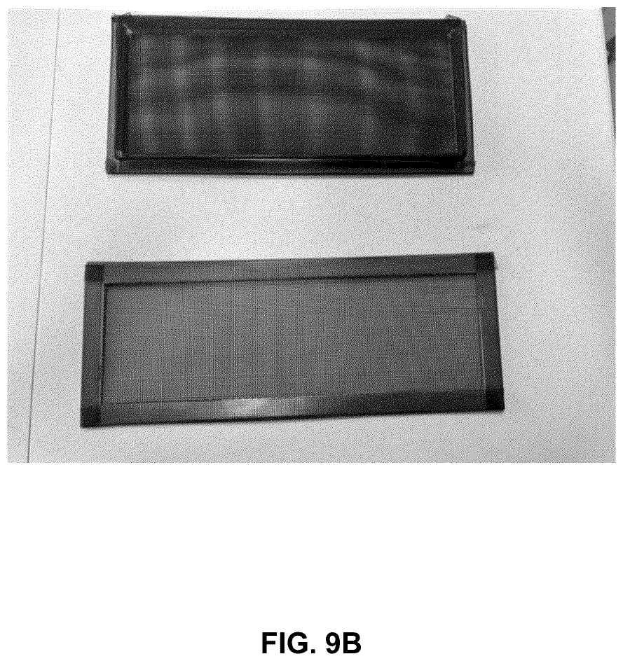

FIG. 9A shows a front view of two embodiments of a framed fire mitigation device according to the current disclosure. The top embodiment includes a double layer of a mesh screen barrier and the bottom embodiment includes a single layer of a mesh screen. FIG. 9B shows a rear view of two embodiments shown in FIG. 9A.

### Testing

Radiant Heat: An embodiment comprised of a wire diameter of 0.018″ and aperture size of 0.0657″ will reduce radiant heat by about 38%. Testing by Australia's Commonwealth Scientific and Industrial Research Organisation (CSIRO) shows that different meshes can reduce the radiant heat reduction. The CSIRO testing shows that the mesh may be an effective heat absorption barrier. Such heat absorption may be due to the diameter and interlocking woven nature of the wires, which reflects and absorbs some of the heat flux. Such heat absorption may also be due to the aperture size, which allows for convective heat to escape, thereby allowing for a reduction in heat transfer.

Some embodiments are able to absorb and reflect radiant heat to reduce the heat from fires being transferred to objects behind the mesh. Embodiments can do this by having an open area of 62%, wire diameter of about 0.0177″, and a concentration of 12 wires per inch (12 mesh).

Embers: A “mini dragon,” or an ember shower simulator, was employed during testing of mitigation during firebrand showers. The outcomes show barrier screening was a minimum of 98% effective in stopping dangerous embers from soft wood, as shown in a paper on testing, Fire Journal by the University of Southern Queensland.

ASTM E2886 testing was conducted by QAI Laboratories, an ISO 17025 accredited lab and approved by the California Office of the State Fire Marshall, which confirmed that 1/16″ aperture mesh is highly effective in stopping dangerous embers.

The above testing has been done by QAI Laboratories according to ASTM E2886/E2886M-14, Standard Test Method for Evaluating the Ability of Exterior Vents to Resist the Entry of Embers and Direct Flame Impingement. Australian Standard 1530.8.1 CSIRO, Australia conducted tests on elements of construction for building exposed to simulated bushfire attacks-radiant heat and small flaming source.

It has been observed that 12 mesh or 10 mesh screens may be best employed for certain applications. For a forest of hardwood trees, 12 mesh (0657″ or 1.67 mm apertures) is found to protect from up to 95% of dangerous embers or firebrands. In a forest with softwood trees, 12 mesh (0.0657″ or 1.67 mm apertures) is found to protect from up to 98% of dangerous embers or firebrands.

Direct Flame: Barrier screening can serve as an effective barrier against direct flame by diffusing the flame when installed vertically. Flame diffusion is the process referred to as heat absorption and radiation reflection. During testing it was identified that a double layer of mesh was not significantly different than a single layer and both performed extremely well. Therefore, a single-layer retrofit solution may be preferred in embodiments, at least for less cost and complexity.

Embodiments may act as a barrier that may prevent convection of hot flame and gas from being transferred from one side of the mesh to another. The mesh can diffuse the flame so the flame length is significantly shorter which means it may not reach any combustible material on the other side of the mesh screen. Testing has shown that under certain conditions the temperature behind a mesh is significantly less than the 350 degrees Celsius (662 degrees Fahrenheit) allowable. Average test results were approximately 100 degrees C. (approximately 212 degrees Fahrenheit) below acceptable levels which is significant in preventing ignition. A typical material ignition temperature for materials in and around a home is expected to be above 350 degrees C. (662 Fahrenheit).

Testing conducted on barrier screening (direct flame) is ASTM E2912-17, Standard Test Method for Fire Test of Non-Mechanical Fire Dampers Used in Vented Construction—Vertical Installation tested by QAI Laboratories, ASTM E84/UL 723, Standard Test Method for Surface Burning Characteristics of Building Materials (30 min test) tested by UL.

ASTM E2912-17 testing confirms that embodiments of the current disclosure meets requirements when vertically installed for SFM Chapter 7A of the California Building Code by not exceeding 350 degrees C., not igniting the cotton pad or creating any visible flame.

### Air Flow

The current mesh sizes for ventilation have been based on embodiments with two aperture sizes: ⅛″ to protect against animals, insect entry and large ember entry into cavities, and 1/16″ to protect against animals, insects and dangerous ember entry into cavities. The table below provides a simple comparison of the different size meshes, wire diameter and net free area. In some embodiments, the ⅛″ aperture mesh is made from galvanized steel wire while the 1/16″ aperture mesh is made from stainless steel wire, which is much stronger and can therefore be made with a smaller diameter.

| | Wire | Net Free Area |
|---|---|---|
| Mesh Aperture | diameter | (NFA) |
| ⅛″ Insect Mesh | .0413″ | 56% |
| ⅛″ Insect Mesh | .0287″ | 66% |
| 1/16″ Wildfire Defense Mesh | .0177″ | 62% |
| (SSWM Bushfire Mesh) | | |

The circulation of air will be impacted if there are restrictions placed in front of vents. Air velocities through the vents are low which results in insignificant resistance to air flow. Building codes (International Residential Codes, IRC) require vents to be designed and rated based on a volume of air to more “ratio” to surface area of vent. These ratios have been designed and rated based on the vents having a mesh screen to prevent animals and insects from entering. The current industry standard is for ⅛″ aperture mesh with an NFA between 56% and 66%. The stainless steel 1/16″ aperture mesh has an NFA of 62%. This means that if the ⅛″ aperture mesh is replaced with 1/16″ aperture mesh that the NFA is within the current building code requirements.

An assessment has been completed and the pressure drops calculated based on different scenarios that show there is no material difference between the three (3) meshes above and that the pressure drops across the different meshes are not significant to prevent various roof cavities and crawl spaces from “breathing.” Therefore, installing 1/16″ aperture stainless steel mesh on vents in place of ⅛″ aperture mesh may have no impact on the vent design and vent ratios which means the building is compliant with building code.

### Methods of Use

Embodiments of the current disclosure may be supplied in various forms. For example, a fire mitigation device may be supplied as one or more pre-framed mesh screens in a defined geometrical shape, such as a rectangle or square. Alternatively, a fire mitigation device may be supplied as a larger mesh screen, for example in a roll, which a user may then cut to any size and shape they wish to suit the particular application of the fire mitigation device. In the latter form, the user may then choose to frame the mesh they cut or to use it as-is.

According to certain embodiments of the current disclosure, the interlocking wires of a mesh may be in a plain weave pattern, a hexagonal mesh pattern, or a different pattern. The weave pattern does not have correct side up. “Interlocking” as used in the present disclosure includes, at a minimum, interwoven wires such as those shown in FIGS. 1 to 9B. There may be other ways to form an interlocking wire mesh that would similarly be considered interlocking without having the wires interwoven.

Embodiments of the current disclosure may be placed on or over vents. Vents that may be protected include vertical eave vents, soffit vents, dormer vents, gable vents, foundation vents, crawl space vents, ridge vents, off-ridge vents, or any other vent or orifice of a structure.

Embodiments of the current disclosure may be cut in a larger format and wrapped around structures such as decks, porches, patios, pavilions, awnings, sunrooms, or any other structure that a user may wish to “screen in.”

Embodiments of the current disclosure may be placed over windows or doors, where a traditional screen window or screen door may be placed.

Embodiments of the current disclosure may be placed over gutters, bird stops, gaps between walls and the roof, weep holes, external inlets and outlets, eaves and soffits, roofs, gulley leaf guards, or any other conceivable structure or feature which a user may wish to protect from the dangers of wildfire.

Embodiments of the current disclosure may also be formed into freestanding barriers which may be placed strategically around a structure or feature which a user may wish to protect from the dangers of wildfire.

When placing a fire mitigation device according to the present disclosure over vents or structural orifices, the user may choose whether to install the wire mesh barrier on the inside or the outside of the vent. In some embodiments, the wire mesh barrier will be placed on the inside of the vent and fastened inside of the structure. In other embodiments, the wire mesh barrier will be fastened to the facade of the structure, over the vent. Fastening the wire mesh barrier to a structure is able to reduce the probability of damage to the building by objects being carried by strong winds.

Upon installation of some embodiments, it is encouraged to extend the mesh to overlap the edges of the opening it protects by 1″ or more. It is also encouraged in some embodiments to place fasteners on any corners of the mesh and at regular and frequent intervals along the edge. This is done in order to avoid openings or gaps between the mesh and the structure that are large enough to let dangerous embers through. In some embodiments, users may also choose to fold over the edges of the mesh in order to create cleaner lines at the edges.

In embodiments which include pre-framed mesh, the frame may be made from a non-corrosive, low maintenance material, such as stainless steel (including 316 or 304 stainless steel), that gives the same or similar protection as the mesh against corrosion, high temperature, and flammability. When fasteners are placed through such a frame, any welded portions should be avoided.

In some embodiments, a fire mitigation device according to the current disclosure will provide a passive barrier. In other embodiments, a fire mitigation device according to the current disclosure may provide an active barrier.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1.-16. (canceled)

17. A fire mitigation method, comprising the steps of:
placing a fire mitigation device in front of a structure to be protected to create a barrier against direct flame, embers, and radiant heat,
wherein the fire mitigation device comprises a mesh screen of interlocking wires comprising 10 to 14 wires per inch;
wherein the mesh screen includes a plurality of apertures that have an aperture width of between 0.04 inches and 0.08 inches;
wherein the mesh screen has a net free area defined by the percentage area of the mesh screen that does not contain wire;
wherein the net free area is between 55% and 70%; and
wherein the mesh screen is configured to catch embers.

18. The fire mitigation method of claim 17, further comprising the step of fastening the fire mitigation device over an opening in the structure to be protected to create a barrier against direct flame, embers, and radiant heat.

19. The fire mitigation method of claim 17, further comprising the step of at least partially wrapping the structure to be protected with the fire mitigation device to defend the structure to be protected against direct flame, ember, and radiant heat.

20. (canceled)

21. The fire mitigation method of claim 17, wherein the mesh screen comprises between 10 and 12 wires per inch.

22. The fire mitigation method of claim 17, wherein the aperture width is between 0.0625 inches and 0.0675 inches.

23. The fire mitigation method of claim 17, wherein the net free area is between 60% and 65%.

24. The fire mitigation method of claim 17, wherein the wires have a diameter of between 0.01 and 0.05 inches.

25. The fire mitigation method of claim 17, wherein the mesh screen has a thickness of between 0.025 and 0.1 inches.

26. The fire mitigation method of claim 17, wherein the wires are non-magnetic.

27. The fire mitigation method of claim 17, wherein the wires are made from stainless steel.

28. The fire mitigation method of claim 27, wherein the wires are made from 316 or 304 stainless steel.

29. The fire mitigation method of claim 17, wherein the wires have a raw finish.

30. The fire mitigation method of claim 17, wherein the wires have a powder coating.

31. The fire mitigation method of claim 17, wherein the wires are at least partially coated with a coating that increases the heat resistance or heat absorption of the wire mesh.

32. The fire mitigation method of claim 17, wherein the fire mitigation device includes a frame that at least substantially surrounds the mesh screen to create a framed mesh screen.

33. The fire mitigation method of claim 18, wherein the fire mitigation device includes a frame that at least substantially surrounds the mesh screen to create a framed mesh screen.

34. The fire mitigation method of claim 17, wherein the interlocking wires are arranged in a plain weave pattern.

35. The fire mitigation method of claim 17, wherein the interlocking wires are arranged in a hexagonal mesh pattern.

36. The fire mitigation method of claim 17, wherein the fire mitigation device further comprises:
a second mesh screen of interlocking wires comprising 8 to 14 wires per inch;
wherein the second mesh screen includes a plurality of second apertures that have a second aperture width of between 0.02 inches and 0.12 inches;
wherein the second mesh screen has a second net free area defined by the percentage area of the second mesh screen that does not contain wire;
wherein the second net free area is between 50% and 75%; and
wherein the mesh screen and the second mesh screen are stacked together.

37. The fire mitigation method of claim 36, wherein the second mesh screen comprises between 10 and 12 wires per inch.
